(19) United States
(12) Patent Application Publication
(10) Pub. No.: US 2012/0186274 A1
(43) Pub. Date: Jul. 26, 2012

(54) METHODS, APPARATUSES, AND COMPUTER PROGRAM PRODUCTS FOR MONITORING FUNCTIONALITY OF A REFRIGERATION SYSTEM

(75) Inventors: Joe Cwiertniewicz, Avondale, AZ (US); Marcus Mandagie, Anaheim, CA (US); Rick Metcalf, Phoenix, AZ (US)

(73) Assignee: McKesson Corporation

(21) Appl. No.: 13/014,359

(22) Filed: Jan. 26, 2011

(51) Int. Cl. F25D 31/00; F25B 49/00; G06F 15/00; F25D 25/00

(52) U.S. Cl. 62/56; 62/62; 62/129; 702/127

(57) ABSTRACT

Methods, apparatuses, and computer program products are provided for monitoring functionality of a refrigeration system. A method may include periodically exercising a refrigeration system to test the refrigeration system. The method may further include monitoring operation of the exercised refrigeration system. The method may additionally include determining, based at least in part on the monitoring, whether the exercised refrigeration system is malfunctioning. The method may also include causing a notification to be provided in an instance in which it is determined that the exercised refrigeration system is malfunctioning. Corresponding apparatuses and computer program products are also provided.

### TECHNOLOGICAL FIELD

Embodiments of the present invention relate generally to refrigeration technology and, more particularly, relate to methods, apparatuses, and computer program products for monitoring functionality of a refrigeration system.

### BACKGROUND

Products that need to be stored in an environment having a temperature within a particular temperature range are often stored in refrigeration units. For example, medical products that need to be maintained at a particular temperature are often stored in refrigeration units known as bio boxes. If the temperature of a refrigeration unit exceeds a maximum tolerable temperature or falls below a minimum tolerable temperature, products stored in the refrigeration unit may be ruined. Such a loss of product inventory may be quite costly. As such, many refrigeration units are equipped with redundant refrigeration systems. In this regard, a refrigeration unit may be quipped with two or more refrigeration systems, each of which may be sufficient to maintain a desired temperature in the refrigeration unit when operating properly. Accordingly, if a primary refrigeration system fails, a backup refrigeration system may maintain the temperature of the refrigeration unit so as to preserve products stored therein. However, as a backup refrigeration system is generally not activated unless the primary refrigeration system fails, problems with a backup refrigeration system may not be known until the primary refrigeration system has failed. As such, if the backup refrigeration system malfunctions as well, product inventory may still be lost without warning in spite of the presence of redundant refrigeration systems.

### BRIEF SUMMARY OF SOME EXAMPLES OF THE INVENTION

Methods, apparatuses, and computer program products are provided herein for monitoring functionality of a refrigeration system. Some example embodiments disclosed herein may provide several advantages for refrigeration units, distributors of products requiring refrigeration, and consumers of products requiring refrigeration. In this regard, some example embodiments provide a refrigeration monitoring apparatus configured to exercise redundant refrigeration systems so as to test the refrigeration systems and make sure that they operate when required. More particularly, a refrigeration monitoring apparatus in accordance with some example embodiments may determine whether a refrigeration system is malfunctioning before a loss of product occurs due to failure of primary and backup refrigeration systems.

The refrigeration monitoring apparatus of some example embodiments is independent of a refrigeration system control system and collects data from non-invasive sensors that may be positioned externally to refrigeration equipment of a refrigeration system. As such, the refrigeration monitoring apparatus of some example embodiments may be installed in a refrigeration unit without requiring modification of a refrigeration system or its control system.

In a first example embodiment, a method for monitoring functionality of a plurality of redundant refrigeration systems implemented in a refrigeration unit is provided. The method of this example embodiment comprises periodically exercising each of the redundant refrigeration systems to test the refrigeration systems. The method of this example embodiment further comprises monitoring operation of an exercised refrigeration system. The method of this example embodiment also comprises determining, based at least in part on the monitoring, whether the exercised refrigeration system is malfunctioning. The method of this example embodiment additionally comprises causing a notification to be provided in an instance in which it is determined that the exercised refrigeration system is malfunctioning.

In another example embodiment, an apparatus for monitoring functionality of a plurality of redundant refrigeration systems implemented in a refrigeration unit is provided. The apparatus of this embodiment comprises at least one processor. The at least one processor is configured to cause the apparatus of this example embodiment to exercise each of the redundant refrigeration systems to test the refrigeration systems. The at least one processor is further configured to cause the apparatus of this example embodiment to monitor operation of an exercised refrigeration system. The at least one processor is additionally configured to cause the apparatus of this example embodiment to determine, based at least in part on the monitoring, whether the exercised refrigeration system is malfunctioning. The at least one processor is also configured to cause the apparatus of this example embodiment to cause a notification to be provided in an instance in which it is determined that the exercised refrigeration system is malfunctioning.

In another example embodiment, a computer program product for monitoring functionality of a plurality of redundant refrigeration systems implemented in a refrigeration unit is provided. The computer program product of this embodiment includes at least one computer-readable storage medium having computer-readable program instructions stored therein. The program instructions of this example embodiment comprise program instructions configured to cause an apparatus to perform a method comprising periodically exercising each of the redundant refrigeration systems to test the refrigeration systems. The method of this example embodiment further comprises monitoring operation of an exercised refrigeration system. The method of this example embodiment also comprises determining, based at least in part on the monitoring, whether the exercised refrigeration system is malfunctioning. The method of this example embodiment additionally comprises causing a notification to be provided in an instance in which it is determined that the exercised refrigeration system is malfunctioning.

In another example embodiment, an apparatus for monitoring functionality of a plurality of redundant refrigeration systems implemented in a refrigeration unit is provided. The apparatus of this example embodiment comprises means for periodically exercising each of the redundant refrigeration systems to test the refrigeration systems. The apparatus of this example embodiment further comprises means for monitoring operation of an exercised refrigeration system. The apparatus of this example embodiment also comprises means for determining, based at least in part on the monitoring, whether the exercised refrigeration system is malfunctioning. The apparatus of this example embodiment additionally comprises means for causing a notification to be provided in an instance in which it is determined that the exercised refrigeration system is malfunctioning.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a refrigeration monitoring apparatus to an example embodiment;

FIG. 2 illustrates a system for monitoring functionality of a refrigeration system according to an example embodiment;

FIG. 3 illustrates an example refrigeration system status display according to an example embodiment;

FIGS. 4-6 illustrate example notifications that may be provided in accordance with an example embodiment;

FIGS. 7A-7E illustrate schematics of an example refrigeration monitoring apparatus in accordance with an example embodiment; and

FIG. 8 illustrates a flowchart according to an example method monitoring functionality of a refrigeration system to an example embodiment.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

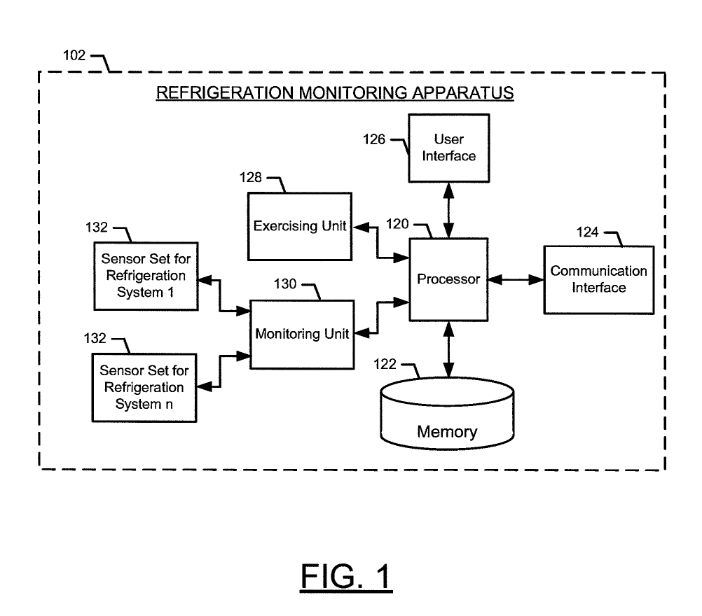

FIG. 1 illustrates a refrigeration monitoring apparatus 102 for monitoring functionality of a refrigeration system according to an example embodiment. It will be appreciated that the refrigeration monitoring apparatus 102 is provided as an example of one embodiment and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a refrigeration monitoring apparatus for monitoring functionality of a refrigeration system, numerous other configurations may also be used to implement embodiments of the present invention.

The refrigeration monitoring apparatus 102 may be implemented in a refrigeration unit, such as a bio box, having a plurality of redundant refrigeration systems. The plurality of redundant refrigeration systems may, for example, comprise a primary refrigeration system and one or more backup refrigeration systems. The backup refrigeration system(s) may serve as a backup to the primary refrigeration system and may not be triggered unless the primary refrigeration system fails to maintain the temperature of the refrigeration unit within a defined threshold temperature.

The refrigeration monitoring apparatus 102 may comprise any computing device or other apparatus configured to monitor refrigeration systems as described herein with respect to one or more example embodiments. By way of example, the refrigeration monitoring apparatus 102 may be embodied as a chipset, one or more integrated circuits, components implemented in a control cabinet, one or more computing devices, any combination thereof, and/or the like. As a further example, the refrigeration monitoring apparatus 102 may comprise a distributed apparatus. In this regard, components and/or functionality attributed to the refrigeration monitoring apparatus 102 may be distributed across a plurality of computing devices and/or other apparatuses, which may be in communication with each other, such as via a bus, a direct wired communication link, a network, some combination thereof, or the like.

The refrigeration monitoring apparatus 102 may be implemented independently of refrigeration system control system(s) for controlling the refrigeration systems implemented in the refrigeration unit. Accordingly, the refrigeration monitoring apparatus 102 of some example embodiments may be implemented in a refrigeration unit without requiring modification to a control system. Advantageously, operation of the refrigeration monitoring apparatus 102 of such example embodiments may not be affected by a failure of a refrigeration system control system.

In an example embodiment the refrigeration monitoring apparatus 102 includes various means for performing the various functions described herein. These means may include, for example, one or more of a processor 120, memory 122, communication interface 124, user interface 126, exercising unit 128, or monitoring unit 130 for performing the various functions herein described. The means of the refrigeration monitoring apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 122) that is executable by a suitably configured processing device (e.g., the processor 120), or some combination thereof.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 120 comprises a plurality of processors. The plurality of processors may be embodied on a single computing device or may be distributed across a plurality of computing devices collectively configured to function as the refrigeration monitoring apparatus 102. The plurality of processors may be in operative communication with each other and may be collectively configured to perform one or more functionalities of the refrigeration monitoring apparatus 102 as described herein. In some example embodiments, the processor 120 is configured to execute instructions stored in the memory 122 or otherwise accessible to the processor 120. These instructions, when executed by the processor 120, may cause the refrigeration monitoring apparatus 102 to perform one or more of the functionalities of the refrigeration monitoring apparatus 102 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may include, for example, volatile and/or non-volatile memory. In this regard, the memory 122 may comprise a non-transitory computer-readable storage medium. Although illustrated in FIG. 1 as a single memory, the memory 122 may comprise a plurality of memories. The plurality of memories may be embodied on a single computing device or distributed across a plurality of computing devices. The memory 122 may comprise volatile memory, non-volatile memory, or some combination thereof. In this regard, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the refrigeration monitoring apparatus 102 to carry out various functions in accordance with example embodiments of the present invention. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. This stored information may be stored and/or used by the exercising unit 128 and/or monitoring unit 130 during the course of performing their functionalities.

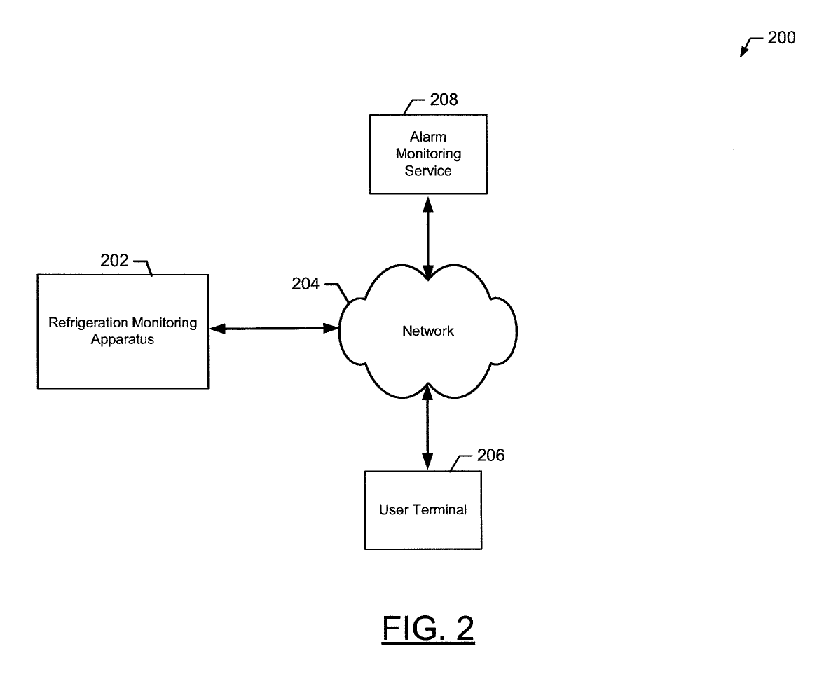

The communication interface 124 may be embodied as any device or means embodied in circuitry, hardware, a computer program product comprising computer readable program instructions stored on a computer readable medium (e.g., the memory 122) and executed by a processing device (e.g., the processor 120), or a combination thereof that is configured to receive and/or transmit data from/to another device, such as, for example, a server, a user terminal (e.g., a user terminal 206 illustrated in FIG. 2), a remote monitoring service (e.g., the alarm monitoring service 308 illustrated in FIG. 2), and/or the like. In at least one embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with another computing device. The communication interface 124 may be configured to receive and/or transmit data using any protocol that may be used for communications between computing devices. The communication interface 124 may additionally be in communication with the memory 122, user interface 126, exercising unit 128, and/or monitoring unit 130, such as via a bus.

The user interface 126 may be in communication with the processor 120 to receive an indication of a user input and/or to provide an audible, visual, mechanical, or other output to a user. As such, the user interface 126 may include, for example, a keyboard, a mouse, a joystick, a display, a touch screen display, a microphone, a speaker, and/or other input/output mechanisms. In some example embodiments, at least some aspects of the user interface 126 may be embodied on an apparatus used by an end user that is in communication with the refrigeration monitoring apparatus 102, such as for example, a user terminal 206 illustrated in FIG. 2. The user interface 126 may provide means for a user to receive notification of a refrigeration system malfunction, view operation data for a refrigeration system, trigger a test of a refrigeration system, set target operating conditions, and/or the like. The user interface 126 may be in communication with the memory 122, communication interface 124, exercising unit 128, and/or monitoring unit 130, such as via a bus.

The exercising unit 128 may be embodied as various means, such as circuitry, hardware, a computer program product comprising computer readable program instructions stored on a computer readable medium (e.g., the memory 122) and executed by a processing device (e.g., the processor 120), or some combination thereof and, in one embodiment, is embodied as or otherwise controlled by the processor 120. In embodiments wherein the exercising unit 128 is embodied separately from the processor 120, the exercising unit 128 may be in communication with the processor 120. The exercising unit 128 may further be in communication with one or more of the memory 122, communication interface 124, user interface 126, or monitoring unit 130, such as via a bus.

The monitoring unit 130 may be embodied as various means, such as circuitry, hardware, a computer program product comprising computer readable program instructions stored on a computer readable medium (e.g., the memory 122) and executed by a processing device (e.g., the processor 120), or some combination thereof and, in one embodiment, is embodied as or otherwise controlled by the processor 120. In embodiments wherein the monitoring unit 130 is embodied separately from the processor 120, the monitoring unit 130 may be in communication with the processor 120. The monitoring unit 130 may further be in communication with one or more of the memory 122, communication interface 124, user interface 126, or exercising unit 128, such as via a bus.

The monitoring unit 130 may be in communication with and configured to receive data from a plurality of sensor sets 132. In this regard, the refrigeration monitoring apparatus 102 may further comprise and/or may otherwise be in operative communication with a sensor set 132 for each refrigeration system that is monitored by the refrigeration monitoring apparatus 102. As such, there may be n sensor sets 132, where n is an integer corresponding to the number of refrigeration systems monitored by the refrigeration monitoring apparatus 102 (e.g., the number of refrigeration systems implemented in the refrigeration unit in which the refrigeration monitoring apparatus 102 is implemented.

A sensor set 132 may include one or more sensors for monitoring operation of a refrigeration system. As an example, the sensor set 132 may include a thermostat calling sensor. A thermostat calling sensor may enable the monitoring unit 130 to monitor when a thermostat is calling for operation of a refrigeration system. A sensor set 132 may additionally or alternatively comprise one or more sensors configured to enable the monitoring unit 130 to determine when a door of the refrigeration unit is open. In this regard, there may, for example, be a door sensor for each door of the refrigeration unit. Larger refrigeration units, such as bio boxes, may include one or more drive-in doors, as well as one or more “man doors.” A sensor set 132 may additionally or alternatively comprise a defrost sensor. A defrost sensor may be configured to enable the monitoring unit 130 to monitor when a refrigeration system is defrosting. A sensor set 132 may further additionally or alternatively comprise a suction line temperature sensor. A suction line temperature sensor may be configured to enable the monitoring unit 130 to monitor a temperature of a suction line of a refrigeration system when the refrigeration system is in operation. A sensor set 132 may further comprise a compressor operation sensor. A compressor operation sensor may be configured to enable the monitoring unit 130 to determine when a compressor of a refrigeration system is in operation. The sensors of a respective sensor set 132 may be positioned externally to refrigeration equipment of the refrigeration system which the sensors are configured to monitor. Accordingly, the sensors may be non-invasive and may not require modification of a refrigeration system which is monitored by the refrigeration monitoring apparatus 102 of some example embodiments.

Referring now to FIG. 2, FIG. 2 illustrates a system 200 for monitoring functionality of a refrigeration system according to an example embodiment. The system 200 may include a refrigeration monitoring apparatus 202 and one or more user terminals 206 configured to communicate over a network 204. The refrigeration monitoring apparatus 202 may, for example, comprise an embodiment of the refrigeration monitoring apparatus 102. The network 204 may comprise a wireless network (e.g., a cellular network, wireless local area network, wireless personal area network, wireless metropolitan area network, and/or the like), a wireline network, or some combination thereof, and in some embodiments comprises the internet. A user terminal 206 may comprise any device configured for use by a user to access refrigeration system operation data, notifications, and/or the like monitored and provided by the refrigeration monitoring apparatus 202 over the network 204. In this regard, a user terminal 206 may be embodied as a desktop computer, laptop computer, mobile terminal, mobile computer, mobile phone, mobile communication device, any combination thereof, and/or the like, which may be configured to receive and/or access refrigeration system operation data from the refrigeration monitoring apparatus 202.

In the example system illustrated in FIG. 2, at least some aspects of the user interface 116 may be embodied on the user terminal 206. Further, at least some of the functionality attributed to the monitoring unit 130 may be performed at the user terminal 206. In this regard, the user terminal 206 may receive data from one or more sensor sets 132 and monitor operation of a refrigeration system, determine whether a refrigeration system is malfunctioning, and/or the like

The system 200 may additionally include an alarm monitoring service 208. The alarm monitoring service 208 may comprise a service for monitoring alarms, notifications, and/or the like that may be generated by the refrigeration monitoring apparatus and/or by the user terminal 206, such as in response to a determination that a refrigeration system is malfunctioning.

The exercising unit 128 may accordingly be configured to exercise the refrigeration systems monitored by the refrigeration monitoring apparatus 102 to test the refrigeration systems. In this regard, the exercising unit 128 may, for example, periodically exercise the refrigeration systems (e.g., once a week, or the like). The exercising unit 128 may exercise the refrigeration systems individually (e.g., one at a time), or may exercise two or more refrigeration systems concurrently. Accordingly, even a backup refrigeration system may be tested to ensure they are operable before they are needed, such as due to failure of a primary refrigeration system. The exercising unit 128 may, for example, be configured to exercise a refrigeration system by causing output of a signal simulating a thermostat calling signal to a refrigeration system.

The sensor set 132 for an exercised refrigeration system may collect data about operation of the exercised refrigeration system, which may be received by the monitoring unit 130. The monitoring unit 130 may accordingly be configured to monitor operation of an exercised refrigeration system based on the data received from a sensor set 132.

The monitoring unit 130 may be further configured to determine whether the exercised refrigeration system is malfunctioning based on the monitoring. As an example, the monitoring unit 130 may be configured to determine whether a compressor of an exercised refrigeration system responded to exercising (e.g., to the simulated thermostat calling signal) of the refrigeration system. In this regard, the monitoring unit 130 may determine based at least in part on information received from a compressor operation sensor whether the compressor is running in response to exercising of the refrigeration system.

As another example, the monitoring unit 130 may be configured to determine whether an exercised refrigeration system is malfunctioning by determining whether the temperature of a suction line of an exercised refrigeration system reached a defined threshold temperature. The defined threshold temperature may, for example, be defined based on manufacturer guidelines, operator preferences, or the like. As an example, a user of the refrigeration monitoring apparatus 102 may define the threshold temperature by way of the user interface 126, a user terminal 206, and/or the like. The monitoring unit 130 may determine whether the suction line temperature reached the defined threshold temperature based at least in part on information received from a suction line temperature sensor. The monitoring unit 130 may wait a predefined delay time following exercising the refrigeration system to determine whether the suction line temperature reached the defined threshold temperature. In this regard, it may take some time subsequent to startup for the suction line temperature to reach the threshold temperature during the course of normal operation.

The monitoring unit 130 may be further configured to monitor a refrigeration system, when in normal operation, such as in response to a thermostat calling signal, to determine whether the refrigeration system is malfunctioning. The monitoring unit 130 may be configured to determine that a refrigeration system is in operation by detecting a thermostat calling signal, detecting operation of a compressor, and/or the like. The monitoring unit 130 may monitor refrigeration system operation substantially similarly as described with respect to monitoring an exercised refrigeration system. Accordingly, the monitoring unit 130 may determine whether a compressor responded to a thermostat calling signal, whether the temperature of a suction line of a refrigeration system in operation reached a defined threshold temperature, and/or the like.

In an instance in which the monitoring unit 130 determines that a refrigeration system (e.g., an exercised refrigeration system or a refrigeration system monitored while in normal operation) is malfunctioning, the monitoring unit 130 may be configured to provide a notification so as to enable an operator of the refrigeration unit and/or other party to take action to repair the malfunctioning refrigeration system. The notification may be provided in any form, including an audio and/or visual alert. As an example, the monitoring unit 130 may relay a signal to the alarm monitoring service 208 notifying of a detected malfunction of a refrigeration system. As a further example, an audible horn or other alarm may be implemented on the refrigeration unit and/or in a monitoring location. The monitoring unit 130 may accordingly be configured to cause a signal to be sent to the alarm to trigger the alarm to sound. The sound made by the alarm may vary depending on the type of malfunction detected. As an additional example, the monitoring unit 130 may be configured to send an e-mail, text message, and/or the like that may provide notification of a system malfunction.

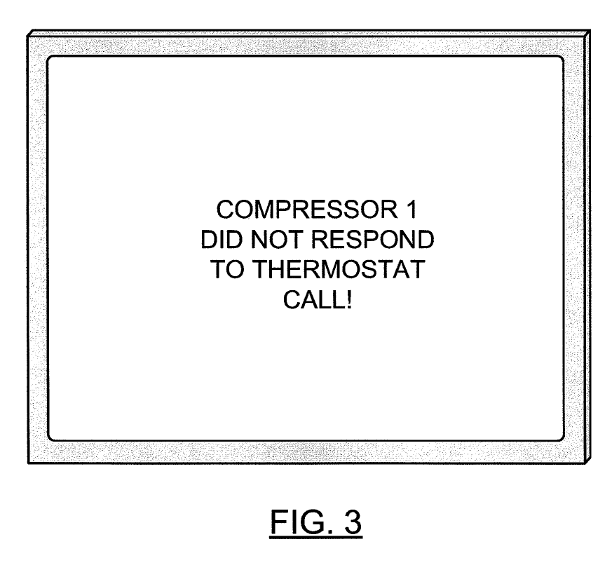

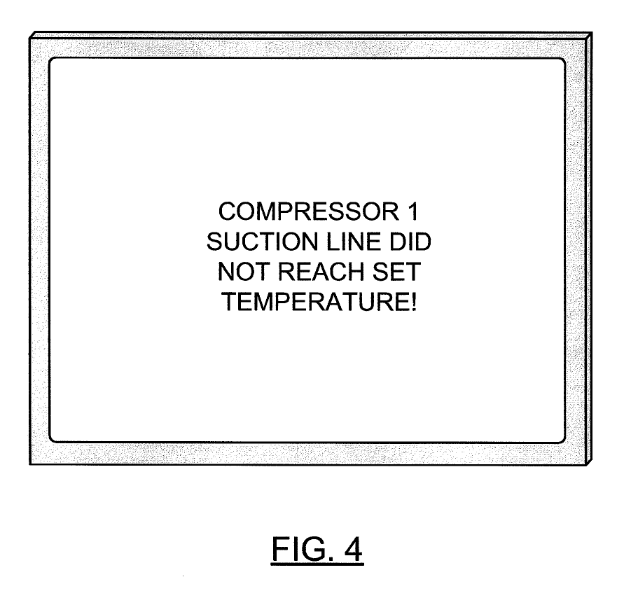

As yet another example, a visual notification may be provided, such as on a display of the refrigeration monitoring apparatus 102, a user terminal 206, and/or of the alarm monitoring service 208. The visual notification may indicate the type of malfunction detected. In this regard, FIG. 3 illustrates an example visual notification that may be provided in an instance in which a compressor of a first refrigeration system did not respond to the simulated thermostat call when exercised. FIG. 4 illustrates an example visual notification that may be provided in an instance in which a temperature of a suction line of a first refrigeration system did not reach a set threshold temperature.

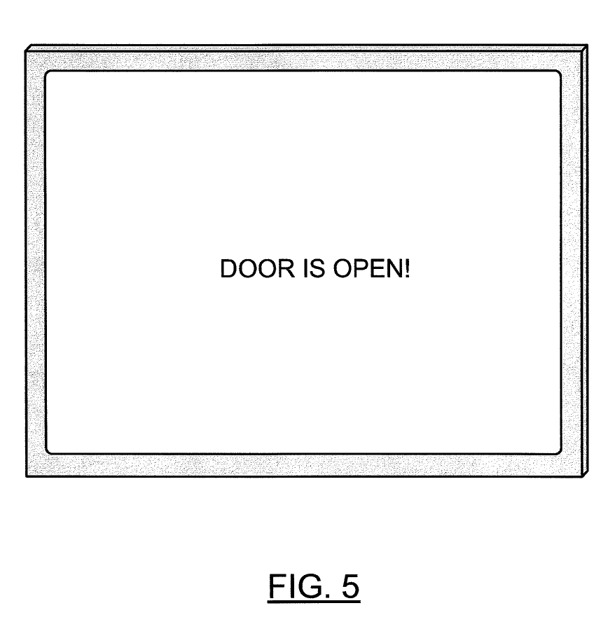

It will be appreciated that the monitoring unit 130 may be configured to provide notifications of events in addition to refrigeration system malfunctions. As an example, the monitoring unit 130 may determine based on information received from a door sensor whether a door of the refrigeration unit is open and/or whether the door has been open for an excessive amount of time. The monitoring unit 130 may accordingly be configured to provide notification that a door is open and/or that the door has been open for longer than a pre set amount of time. In this regard, FIG. 5 illustrates an example visual notification that may be provided to indicate that a refrigeration unit door is open.

A user may silence an alarm and/or acknowledge a notification through the user interface 126. In this regard, a user may provide input to the refrigeration monitoring apparatus 102 acknowledging or dismissing a notification. The monitoring unit 130 may cease providing the notification in response to such user input.

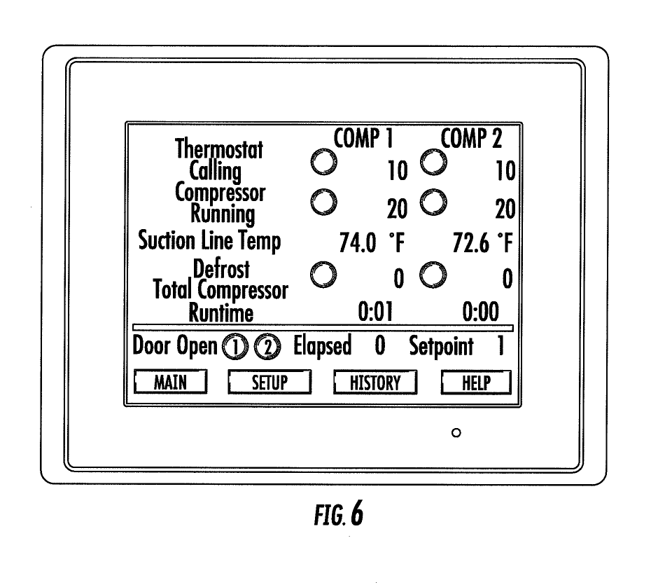

The monitoring unit 130 may be further configured to collect operational data during operation (e.g., normal operation) of the monitored refrigeration systems. In this regard, the monitoring unit may be configured to determine when a refrigeration system is operating, such as in response to a thermostat calling signal, for a defrost cycle, and/or the like and collect operation statistics for the refrigeration system. The collected data may be determined based at least in part on information received from the sensor sets 132. In this regard, the monitoring unit 130 may track a total compressor runtime, a total defrost cycle runtime, a number of defrost cycles, a number of malfunction notifications, a number of alarms, and/or the like over a period of time. The collected data may be maintained in a log, such as may be stored in the memory 122, in a memory of a remote device, such as a user terminal 206, and/or the like. Accordingly, a maintenance person and/or other user may access the data, such as to aid in diagnosing any malfunctions or other problems with a refrigeration system. As an example, FIG. 6 illustrates an example refrigeration system status display, such as may be displayed on a display of the refrigeration monitoring apparatus 102, user terminal 206, and/or other computing device based on operation data collected and logged by the monitoring unit 130.

The monitoring unit 130 may be further configured to determine based on collected data whether a compressor has been running for an excessive amount of time. In this regard, there may be a problem with a refrigeration system and/or with a refrigeration unit if a compressor runs for an excessive amount of time (e.g., for more than a defined amount of time over a defined period). For example, if a compressor is running for an excessive amount of time, there may be a problem with the refrigeration system that may cause it to operate inefficiently. If the monitoring unit 130 determines that a compressor has been running for an excessive amount of time, the monitoring unit 130 may provide a notification thereof.

As another example, the monitoring unit 130 may be configured to determine based on collected data whether there is a refrigeration system has run in a defrost cycle for an excessive amount of time (e.g., for more than a defined amount of time over a period of time) and/or whether a refrigeration system has run an excessive number of defrost cycles (e.g., more than a defined number of defrost cycles in a period of time). The monitoring unit 130 may be further configured to provide a notification of such ad determination.

A user may define a logging period for collecting refrigeration system operational data. In this regard, the monitoring unit 130 may be configured to purge old data collected outside of a defined logging period. A user may also be able to purge and/or otherwise reset a data log.

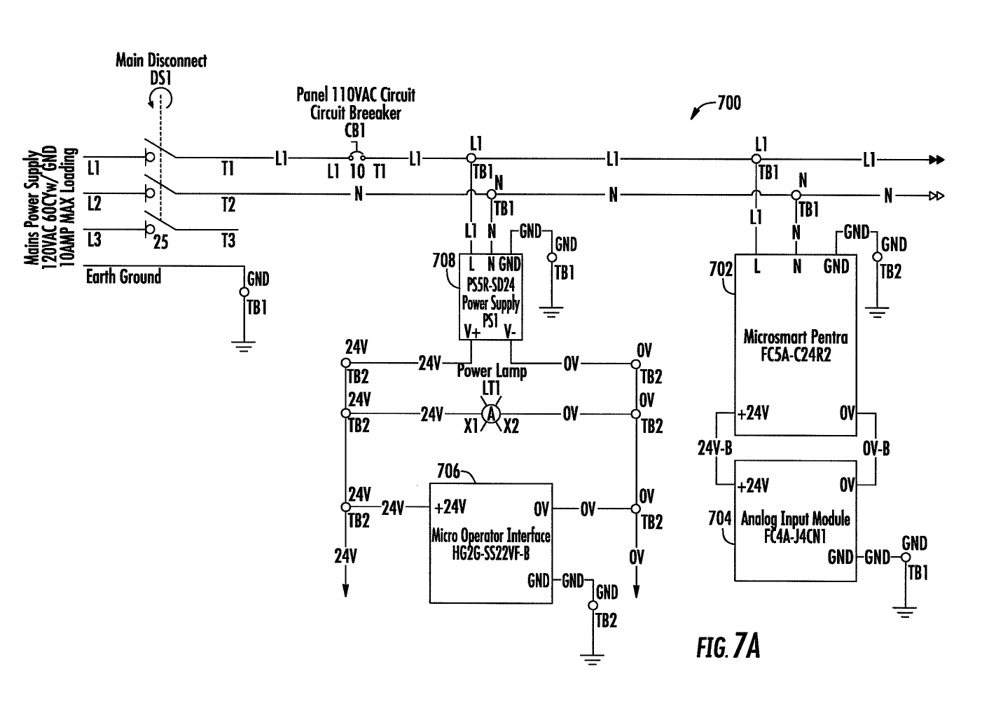

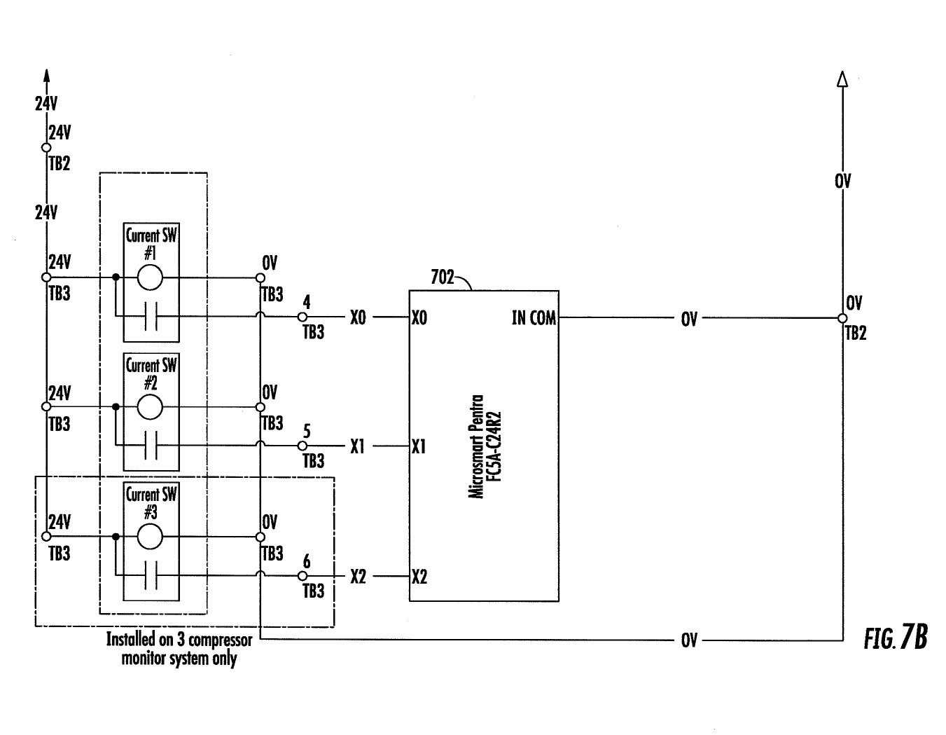

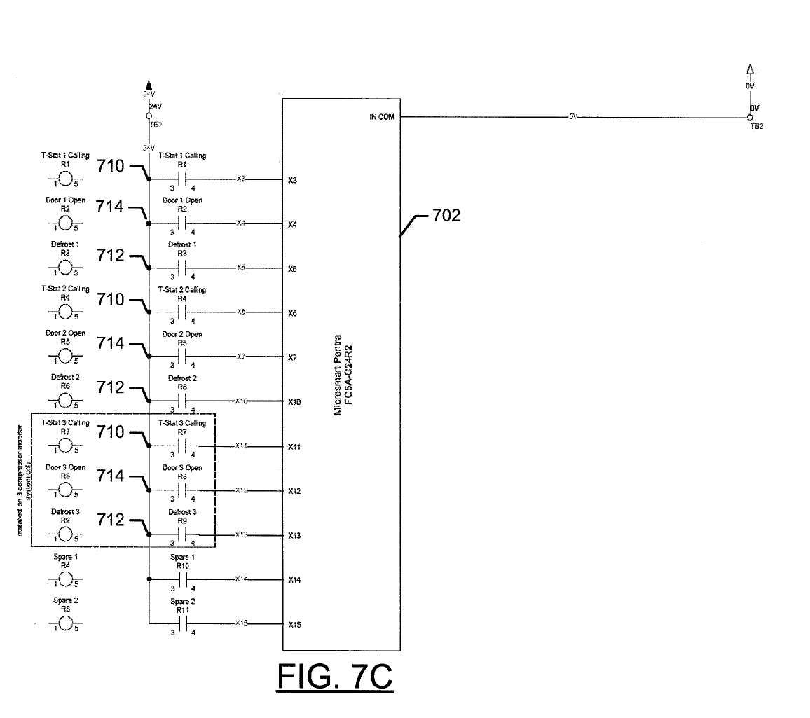

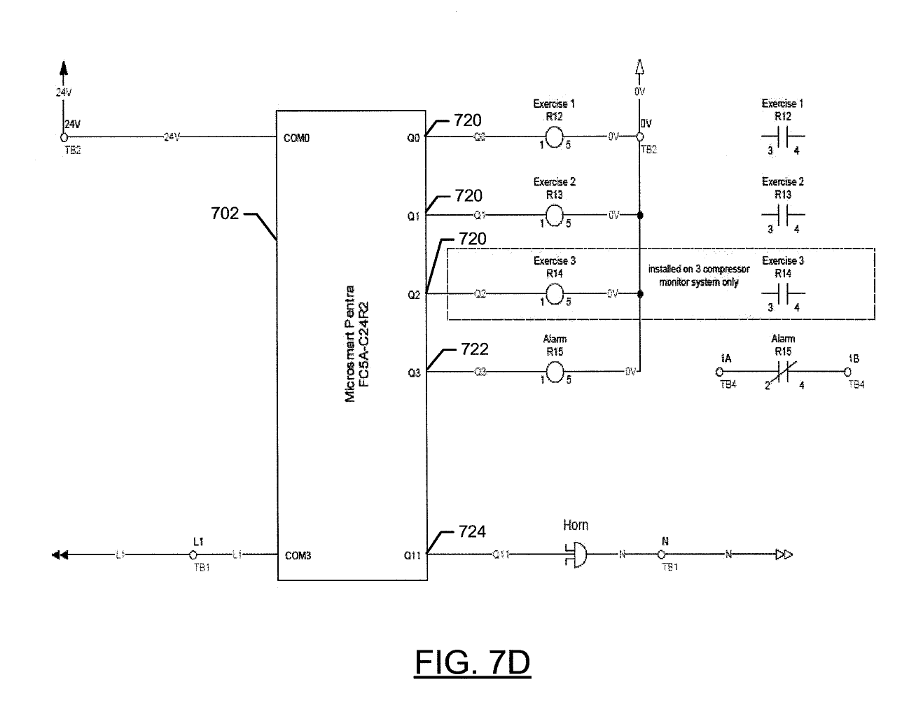

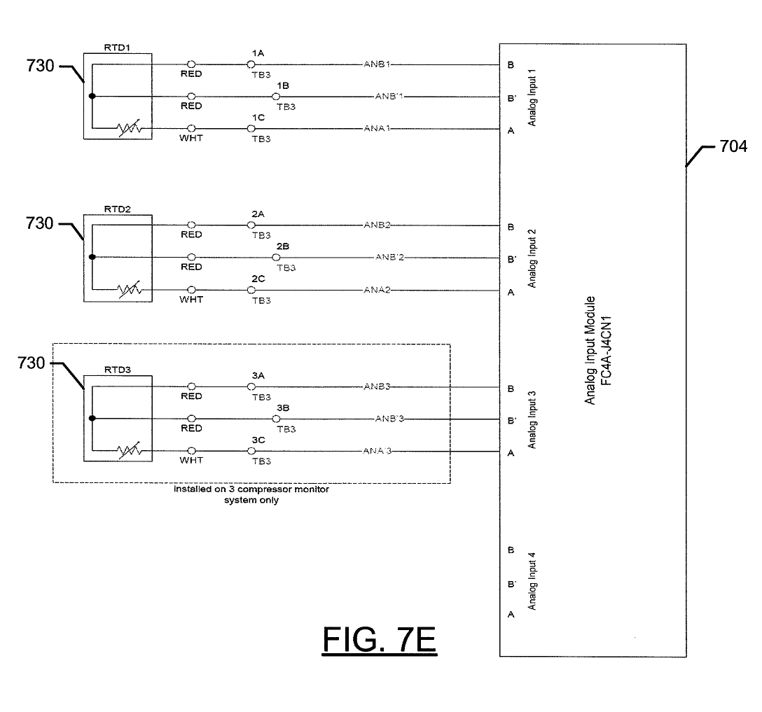

Having now described general operation and example implementations of the refrigeration monitoring apparatus 102 in accordance with some example embodiments, a specific example implementation of the refrigeration monitoring apparatus 102 will be described with respect to FIGS. 7A-7E. In this regard, FIG. 7A illustrates a high level schematic of components of a refrigeration monitoring apparatus 700 and the powering of those components. The refrigeration monitoring apparatus 700 may comprise an example implementation of the accordance with an example embodiment.

The refrigeration monitoring apparatus 700 may comprise several components. The components may include a programmable logic controller (PLC) 702. The PLC 702 may, for example, comprise an embodiment of the processor 120 and at least a portion of the memory 122. The PLC 702 may further embody, control, and/or otherwise implement at least some of the functionality attributed to the exercising unit 128 and monitoring unit 130. In an example embodiment, the PLC 702 may be implemented on a Microsmart Pentra FC5A-C24R2 PLC. However, it will be appreciated that other types of processors, ASICs, PLCs, and/or the like may be substituted for the Microsmart Pentra FC5A-C24R2 PLC in various example embodiments.

The refrigeration monitoring apparatus 700 may further include an analog input module 704. The analog input module 704 may, for example be coupled to the PLC 702 to enable the PLC 702 to receive one or more analog inputs (e.g., sensor inputs). As such, the analog input module 704 may comprise an embodiment of and/or may implement at least some of the functionality attributed to the monitoring unit 130. In an example embodiment, the analog input module may comprise a Microsmart FC4A-J4CN1 Analog Input Module. However, it will be appreciated that other analog input components may be substituted for the Microsmart FC4A-J4CN1 in various example embodiments.

The PLC 702 may be configured to monitor sensor inputs (e.g., sensor inputs from a plurality of sensor sets 132). In this regard, the PLC 702 may be configured to monitor a thermostat calling signal, compressor running signal, suction line temperature, defrost signal, whether a door is open, and/or the like. The PLC 702 may be further configured to provide a variety of outputs dependent on the condition of sensor inputs. The outputs may include, for example, a signal to exercise a refrigeration system (e.g., an exercise compressor signal), an alarm signal, a horn signal, and/or the like.

The PLC 702 may be configured to receive the suction line temperature of a suction line of a refrigeration system from a RTD (resistance temperature device) sensor via the analog input module 704. The PLC 702 may be further configured to examine a thermostat calling signal, defrost signal, and/or a compressor running signal to determine whether a compressor of a refrigeration system has failed. The PLC 702 may be configured to make this determination subsequent to a defined delay time following a signal to activate the compressor. This delay time may, for example, be defined by a user.

The PLC 702 may be additionally configured to examine the thermostat calling signal, defrost signal, and/or compressor running signal and compare a defined target suction line temperature with an actual monitored suction line temperature to determine a suction line alarm. The PLC 702 may be configured to make this comparison subsequent to a delay time following compressor activation. This delay time may, for example, be defined by a user.

The PLC 702 may be further configured to periodically output a signal (e.g., once a week) to exercise each compressor to ensure compressor is working properly. The output signal may, for example, simulate a thermostat calling signal.

The PLC 702 may additionally be configured to track the runtime hours of each compressor and may trigger a compressor excessive runtime notification after a defined time period.

The PLC 702 may also be configured to count the number of defrost cycles of a refrigeration system and/or a defrost cycle runtime. The PLC 702 may be configured to trigger a notification of excessive defrost cycles after a defined number of defrost cycles have occurred in a period of time. Additionally or alternatively, the PLC 702 may be configured to trigger a defrost excessive runtime notification after a defined time period.

The PLC 702 may be configured to examine a door open signal from a door sensor. If the PLC 702 determines that a door has been opened for longer than a defined period of time, the PLC 702 may trigger a door open notification. The door open notification may comprise sounding a horn or alarm.

If an audible alarm is sounded for a notification (e.g., malfunction notification, door open notification, and/or the like), the PLC 702 may be configured to silence the alarm for at least a defined period of time in response to user input. In some example embodiments, however, the PLC 702 may not silence a door open notification alarm until the door is closed. In some example embodiments, the PLC 702 may be configured to cause a notification to be sent to an alarm monitoring service when an alarm condition (e.g., malfunction, door open, and/or the like) is present.

The refrigeration monitoring apparatus 700 may further comprise an operator interface (OI) 706. The OI 706 may comprise an implementation of at least a portion of the user interface 126. In an example embodiment, the OI 706 may comprise an IDEC HG2G-SS22VF-B. It will be appreciated that other operator interfaces may be used in addition to or in lieu of an IDEC HG2G-SS22VF-B in some example embodiments.

The OI 706 may be configured to integrate with the PLC 702. The OI 702 may be configured to display of the status of the thermostats, compressors, suction line temperature, defrost cycle, compressor runtime hours, door open status, a history log, and/or the like. The OI 702 may additionally be configured to allow for maintenance personnel to view the time delays, adjust the time delays, adjust the target suction line temperature, view help screens, clear history log, reset compressor runtime hours, reset defrost cycles, purge the history log, and/or the like. Additionally, the OI 706 may be configured to display visual notifications and alarms.

The refrigeration monitoring apparatus 700 may additionally include a power supply 708, which may be configured to power the components 702-706. The PLC 702, analog input module 704, and power supply 708 may, for example, be implemented in a control box, which may be mounted on a refrigeration unit. The OI 706 may, also be implemented on the control box, but may also be implemented remotely from the control box.

Referring now to FIG. 7B, FIG. 7B illustrates an example schematic of compressor operation sensor inputs to the PLC 702. In this regard, a compressor operation sensor may be implemented as a current switch. There may be a current switch input for each compressor (e.g., for each refrigeration system) of a refrigeration unit on which the refrigeration monitoring apparatus 700 is implemented. In the example of FIG. 7B, two such current switches (Current SW #1 and Current SW #2) are illustrated as being implemented. Further, Current SW #3 is illustrated as being implementable in a three compressor (e.g., three refrigeration system environment). It will be appreciated that where example embodiments are described with respect to two or three refrigeration systems, those embodiments may be scaled up to any number of refrigeration systems by adding additional sets of sensors, relays, and the like for monitoring the additional refrigeration systems.

A current switch may be used by the PLC 702 to detect current from a compressor when in operation. A current switch may supply a direct input to the PLC 702. The PLC 702 may accordingly be configured to use a signal from a current switch to detect if the compressor is running or not.

Installation procedures of installing a current switch may include installing a three conductor cable to each current switch from a control cabinet for the refrigeration monitoring apparatus 700. The cable may, for example, be a cable having a minimum of 18 AWG (American Wire Gauge). The current switch may be mounted inside the mechanical systems control cabinet in a location (e.g., on the back wall of the refrigeration unit) that will allow for re-routing one of the three phase feeds from the load side of the compressor contactor thru the current switch. The refrigeration monitoring apparatus 700 may include a terminal block labeled CURRENT SW#, which may serve as the termination point of the three conductor cable. For example, as illustrated in FIG. 7B:
CURRENT SW 1, TB3-24V, 0V, 4
CURRENT SW 2, TB3-24V, 0V, 5
CURRENT SW 3. TB3-24V, 0V, 6

Referring now to FIG. 7C, FIG. 7C illustrates an example schematic of additional sensor inputs to the PLC 702. These additional sensor inputs may comprise a set of sensor inputs for each refrigeration system implemented on the refrigeration unit on which the refrigeration monitoring apparatus 700 is implemented. Each set of sensor inputs may, for example, comprise a thermostat calling sensor input (T-Stat Calling) 710 and a defrost sensor input 712. Two sets of sensor inputs and an additional optional set of sensor inputs for refrigeration units having three refrigeration systems are illustrated in FIG. 7C. However, it will be appreciated that example embodiments may be scaled to include a number of sets of sensor inputs corresponding to the number of refrigeration systems that are monitored. The additional sensor inputs may further include a door sensor input 714 for each door of the refrigeration unit. The number of door sensor inputs 714 may accordingly vary depending on the number of doors in the refrigeration unit.

The refrigeration monitoring apparatus 700 may include or may otherwise be in communication with a mixture of relays that may be used to relay a signal from sensors to the PLC 702. These sensor signals may be referred to as “inputs.” The relays may be used to accommodate a multiplicity of different signals (voltages) that may be used in a refrigeration system. Accordingly, relays may be swappable to accommodate various refrigeration units in which the refrigeration monitoring apparatus may be implemented and/or various refrigeration systems which may be monitored.

The t-stat calling input 710 may be used by the PLC 702 to monitor when a thermostat is calling for mechanical operation of a refrigeration system. Typical refrigeration units may have one thermostat for each refrigeration system. The t-stat calling input may, for example, be relayed from R1, R4 and/or R7, as illustrated in FIG. 7C.

Installation of a thermostat calling sensor may include using a jumper from the load side wire of the thermostat from the exercise function. Further, a wire may be installed from the opposite side of the control circuit. The refrigeration monitoring apparatus 700 may be supplied with a terminal block labeled THERMOSTAT #X, which may serve as the termination point of the two thermostat calling sensor wires. For example, as illustrated in FIG. 7C:
T-Stat 1 Calling, R1-NO Contact (1-5)
T-Stat 2 Calling, R4-NO Contact (1-5)
T-Stat 3 Calling, R7-NO Contact (1-5)

The defrost input 712 may be used by the PLC 702 to monitor whether a refrigeration system is defrosting. If a defrosting cycle functionality is not implemented on a refrigeration system, monitoring defrosting may be omitted. The defrost input 712 may, for example, be relayed from R3, R6 and/or R9, as illustrated in FIG. 7C.

Installation of a defrost sensor may include using a jumper wire from the line side wire of the thermostat used with the exercise function as one conductor. Further, a wire may be installed to the output side of the NC contact located on the refrigeration system defrost timer. The refrigeration monitoring apparatus 700 may be supplied with a terminal block labeled DEFROST #X, which may serve as the termination point of the two defrost sensor wires. For example, as illustrated in FIG. 7C:
Defrost 1, R3-NO Contact (1-5)
Defrost 2, R6-NO Contact (1-5)
Defrost 3, R9-NO Contact (1-5)

The door open input 714 may be used by the PLC 702 to monitor when a refrigeration unit door is open. The door open input 714 may, for example, be relayed from R2, R5 and/or R8, as illustrated in FIG. 7C.

The door sensors may, for example, be embodied as limit switches. Installation of a door sensor may include installing two wires per electrical code from each limit switch. The refrigeration monitoring apparatus 700 may be supplied with a terminal block labeled DOOR OPEN #X, which may serve as the termination point of the two door sensor wires. For example, as illustrated in FIG. 7C:
Door 1 Open, R2-NO Contact (1-5)
Door 2 Open, R5-NO Contact (1-5)
Door 3 Open, R8-NO Contact (1-5)

Referring now to FIG. 7D, FIG. 7D illustrates an example schematic of output functions of the PLC 702 in accordance with an example embodiment. The PLC 702 may be configured to implement an exercise function (outputs 720 in FIG. 7D). There may be an exercise output function implemented for each refrigeration system monitored by the refrigeration monitoring apparatus 702. An exercise function output 720 may, for example, simulate a thermostat calling signal for a predetermined amount of time that allows for the refrigeration system to operate. Accordingly, the exercise function may be used by the PLC 702 to ensure all mechanical systems of a refrigeration system are capable of starting when required. The exercise function may, for example, be controlled by supplying a 24 VDC signal on an output 720 to a relay (R12, R13, R14).

Installation procedures for implementing an exercise function may, for example, include installing two wires that meet the capacity of the thermostat circuit of the respective refrigeration system. A first wire may be installed to the load side of the thermostat and the second wire may be installed to the line side of the thermostat. The refrigeration monitoring apparatus 700 may be supplied with a terminal block labeled EXERCISE#, which may serve as the termination point of the wires for the exercise function. For example, as illustrated in FIG. 7D:
Exercise 1, R12-Coil (3-4)
Exercise 2, R13-Coil (3-4)
Exercise 3, R14-Coil (3-4)

The alarm function may be used by the PLC 702 to alert an alarm monitoring service 208 that an alarm is present. The alarm notification may comprise a general notification or may comprise a specific reference to a detected malfunction or condition. The alarm function may be controlled by supplying a signal (e.g., a 24 VDC signal) via the output 722 to a relay (R15). The alarm monitoring service may install a point that monitors R15 via a normally closed (NC) contact. The termination point for the alarm monitoring service may be labeled “ALARM” on TB-4 (1A-1B), as illustrated in FIG. 7D.

The horn function may be controlled by output 724 and may be used by the PLC 702 to activate an audible horn, which may be used to signal that an alarm is present. The horn may be controlled by supplying a signal (e.g., a 24 VDC signal) to the horn via the output 724.

Referring now to FIG. 7E, FIG. 7E illustrates an example schematic of inputs to the analog input module 704. In this regard, a suction line temperature sensor may be implemented as a resistance temperature device (RTD). In the example illustrated in FIG. 7E, two RTDs 730 are illustrated as being implemented and an additional optional RTD 730 is illustrated for use for refrigeration units having three refrigeration systems. However, it will be appreciated that example embodiments may be scaled to include a number RTDs 730 and corresponding inputs to the analog input module 704 corresponding to the number of refrigeration systems that are monitored.

The output of an RTD 730 may be received by the analog input module 704 and relayed to the PLC 702. As such, the PLC 702 may determine the temperature of a suction line of a refrigeration system. The PLC 702 may compare a monitored suction line temperature to a defined target, or threshold, suction line temperature.

Installation of an RTD 730 may include installing a three conductor cable to a suction line from a control cabinet for the refrigeration monitoring apparatus 700. The cable may, for example, be a minimum of 18 AWG. The RTD 730 may be secured to the exterior of the suction line, such as with electrical tape or the like. The RTD 730 may be positioned in direct contact with the suction line, which may be reinsulated after installation of the RTD 730 is complete. The RTD 730 may be positioned on the suction line just before a leading evaporator on a main header of the refrigeration system. The refrigeration monitoring apparatus 700 may, for example, be supplied with a terminal block labeled RTD #, which may serve as the termination point of the three conductor cable for an RTD 730. For example, as illustrated in FIG. 7E:
RTD 1, TB3-1A, 1B, 1C
RTD 2, TB3-2A, 2B, 2C
RTD 3, TB3-3A, 3B, 3C

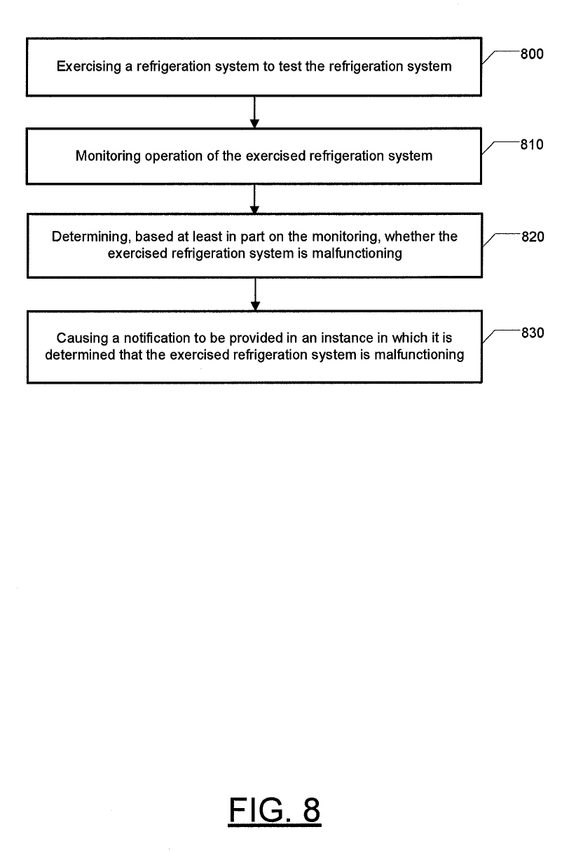

FIG. 8 illustrates a flowchart according to an example method monitoring functionality of a refrigeration system to an example embodiment. The operations illustrated in and described with respect to FIG. 8 may, for example, be performed by, with the assistance of, and/or under the control of one or more of the processor 120, memory 122, communication interface 124, user interface 126, exercising unit 128, monitoring unit 130, or sensor set 132. Operation 800 may comprise exercising (e.g., periodically) a refrigeration system to test the refrigeration system. The processor 120, memory 122, and/or exercising unit 128 may, for example, provide means for performing operation 800. Operation 810 may comprise monitoring operation of the exercised refrigeration system. The processor 120, memory 122, monitoring unit 130, and/or a sensor set 132 may, for example, provide means for performing operation 810. Operation 820 may comprise determining, based at least in part on the monitoring, whether the exercised refrigeration system is malfunctioning. The processor 120, memory 122, and/or monitoring unit 130 may, for example, provide means for performing operation 820. Operation 830 may comprise causing a notification to be provided in an instance in which it is determined that the exercised refrigeration system is malfunctioning. The processor 120, memory 122, communication interface 124, user interface 126, and/or monitoring unit 130 may, for example, provide means for performing operation 820.

FIG. 8 illustrates a flowchart of a system, method, and computer program product according to example embodiments of the invention. It will be understood that each block or step of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices (e.g., the memory 122) of a server, desktop computer, laptop computer, mobile computer, or other computing device (e.g., the refrigeration monitoring apparatus 102, user terminal 206, combination thereof, and/or the like) and executed by a processor (e.g., the processor 120) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s) or step(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s) or step(s). The computer program instructions of one or more computer program products may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowcharts support combinations of means for performing the specified functions and combinations of steps for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for monitoring functionality of a plurality of redundant refrigeration systems implemented in a refrigeration unit, the method comprising:
periodically exercising each of the redundant refrigeration systems to test the refrigeration systems;
monitoring, by a refrigeration monitoring apparatus, operation of an exercised refrigeration system;
determining, based at least in part on the monitoring, whether the exercised refrigeration system is malfunctioning; and
in an instance in which it is determined that the exercised refrigeration system is malfunctioning, causing a notification to be provided.

2. The method of claim 1, wherein the plurality of refrigeration systems comprises a primary refrigeration system and a backup refrigeration system, wherein in an instance in which operation of a refrigeration system is triggered in response to a temperature of the refrigeration unit exceeding a predefined threshold temperature setting, the backup refrigeration system is not triggered unless the primary refrigeration system fails, and wherein monitoring operation of an exercised refrigeration system comprises monitoring operation of the backup refrigeration system to determine whether the backup refrigeration system is malfunctioning.

3. The method of claim 1, wherein exercising a refrigeration system comprises causing output of a signal simulating a thermostat calling signal to a refrigeration system.

4. The method of claim 1, wherein the refrigeration monitoring apparatus is implemented independently of a refrigeration system control system.

5. The method of claim 1, wherein monitoring operation of an exercised refrigeration system comprises monitoring operation of an exercised refrigeration system based at least in part on information received from at least one sensor positioned externally to refrigeration equipment of the exercised refrigeration system.

6. The method of claim 1, wherein determining whether the exercised refrigeration system is malfunctioning comprises determining whether a compressor of the refrigeration system responded to exercising of the exercised refrigeration system.

7. The method of claim 1, wherein determining whether the exercised refrigeration system is malfunctioning comprises determining whether a suction line temperature reached a defined threshold temperature.

8. The method of claim 1, wherein causing a notification to be provided comprises causing notification to be provided to a monitoring service.

9. The method of claim 1, further comprising:
collecting operational data during operation of one of the plurality of refrigeration systems; and
maintaining a log of the collected operational data.

10. The method of claim 1, wherein the refrigeration unit comprises a bio box for storing medical supplies.

11. An apparatus for monitoring functionality of a plurality of redundant refrigeration systems implemented in a refrigeration unit, the apparatus comprising at least one processor, wherein the at least one processor is configured to cause the apparatus to:
periodically exercise each of the redundant refrigeration systems to test the refrigeration systems;
monitor operation of an exercised refrigeration system;
determine, based at least in part on the monitoring, whether the exercised refrigeration system is malfunctioning; and
in an instance in which it is determined that the exercised refrigeration system is malfunctioning, cause a notification to be provided.

12. The apparatus of claim 11, wherein the plurality of refrigeration systems comprises a primary refrigeration system and a backup refrigeration system, wherein in an instance in which operation of a refrigeration system is triggered in response to a temperature of the refrigeration unit exceeding a predefined threshold temperature setting, the backup refrigeration system is not triggered unless the primary refrigeration system fails, and wherein the at least one processor is configured to cause the apparatus to monitor operation of an exercised refrigeration system at least in part by monitoring operation of the backup refrigeration system to determine whether the backup refrigeration system is malfunctioning.

13. The apparatus of claim 11, wherein the at least one processor is configured to cause the apparatus to exercise a refrigeration system by causing output of a signal simulating a thermostat calling signal to a refrigeration system.

14. The apparatus of claim 11, wherein the apparatus is implemented independently of a refrigeration system control system.

15. The apparatus of claim 11, wherein the at least one processor is configured to cause the apparatus to monitor operation of the exercised refrigeration system based at least in part on information received from at least one sensor positioned externally to refrigeration equipment of the exercised refrigeration system.

16. The apparatus of claim 11, wherein the at least one processor is configured to cause the apparatus to determine whether the exercised refrigeration system is malfunctioning at least in part by determining whether a compressor of the refrigeration system responded to exercising of the exercised refrigeration system.

17. The apparatus of claim 11, wherein the at least one processor is configured to cause the apparatus to determine whether the exercised refrigeration system is malfunctioning at least in part by determining whether a suction line temperature reached a defined threshold temperature.

18. The apparatus of claim 11, wherein the at least one processor is configured to cause the apparatus to cause a notification to be provided at least in part by causing notification to be provided to a monitoring service.

19. The apparatus of claim 11, wherein the refrigeration unit comprises a bio box for storing medical supplies.

20. A computer program product for monitoring functionality of a plurality of redundant refrigeration systems implemented in a refrigeration unit, the computer program product comprising at least one non-transitory computer-readable storage medium having computer-readable program instructions stored therein, the computer-readable program instructions comprising program instructions configured to cause a refrigeration monitoring apparatus to perform a method comprising:
periodically exercising each of the redundant refrigeration systems to test the refrigeration systems;
monitoring operation of an exercised refrigeration system;
determining, based at least in part on the monitoring, whether the exercised refrigeration system is malfunctioning; and
in an instance in which it is determined that the exercised refrigeration system is malfunctioning, causing a notification to be provided.
